(19) United States
(12) Patent Application Publication
(10) Pub. No.: US 2024/0272341 A1
(43) Pub. Date: Aug. 15, 2024

(54) DISPLAY PANEL, MANUFACTURING METHOD THEREOF, DISPLAY DEVICE, AND ELECTRONIC DEVICE

(71) Applicants: Interface Technology (ChengDu) Co., Ltd., Chengdu (CN); Interface Optoelectronics (Shenzhen) Co., Ltd., Shenzhen (CN); General Interface Solution Limited, Miaoli (TW)

(72) Inventors: Chu-Jung LIN, Chengdu (CN); Pei-Hsun WU, Chengdu (CN)

(21) Appl. No.: 18/239,853

(22) Filed: Aug. 30, 2023

(30) Foreign Application Priority Data
Feb. 9, 2023 (CN) 202310102423.3

(51) Int. Cl. G02B 5/30

(52) U.S. Cl. CPC G02B 5/3025

(57) ABSTRACT

A display panel includes: a display module including a non-display area, and a plurality of functional holes being arranged in the non-display area in a first direction; and a first polarizer arranged on a display side of the display module in the first direction. The first polarizer is provided with a plurality of light transmission holes independent of each other in the first direction, and the light transmission holes correspond to the functional holes one by one.

### CROSS REFERENCE TO RELATED APPLICATIONS

This application claims priority to Chinese patent application No. 2023101024233, filed on Feb. 9, 2023, the entire contents of which are incorporated herein by reference in their entirety.

### TECHNICAL FIELD

The present disclosure relates to the field of display technology, in particular, to a display panel, a manufacturing method of the display panel, a display device, and an electronic device.

### BACKGROUND

Currently, in order to meet use requirements of thinner and lighter display panels with narrow borders, functional devices such as photosensitive devices (such as cameras, infrared (IR) cameras, fingerprint recognition modules) are designed and integrated into a display panel module corresponding to light transmission holes on a protective glass, to remove a protective glass layer. Therefore, it is necessary to remove a polarizer and a part of an ink layer corresponding to functional devices to form a functional opening area, so that light can pass through without being blocked by the polarizer, and photosensitive devices under the display panel can receive the light passing through the functional opening area to achieve the photosensitive function. However, in this way, the display panel displays different colors.

### SUMMARY

Accordingly, it is necessary to provide a display panel and a manufacturing method of the display panel, a display device, and an electronic device, so as to improve the integrity of the display panel and improve the appearance of the display panel.

According to one aspect of the present disclosure, an embodiment of the present disclosure provides a display panel, including:
a display module including a non-display area, and a plurality of functional holes being arranged in the non-display area in a first direction; and
a first polarizer arranged on a display side of the display module in the first direction.

The first polarizer is provided with a plurality of light transmission holes independent of each other in the first direction, and the light transmission holes correspond to the functional holes one by one.

In an embodiment, the first polarizer includes a bonding layer, a polarizing layer and a protective layer that are sequentially arranged in the first direction.

The light transmission holes extend through the bonding layer, the polarizing layer and the protection layer in the first direction.

In an embodiment, an anti-reflection layer is arranged in each of the light transmission holes.

The anti-reflection layer is bonded to the display side of the display module.

In an embodiment, in the first direction, a plane where a side of the anti-reflection layer away from the display module is positioned, is located upstream of a plane where a side of the protective layer away from the display module is positioned.

In an embodiment, a transparent filling layer is filled in each of the light transmission holes.

In an embodiment, a thickness of the transparent filling layer is less than or equal to a thickness of the first polarizer.

In an embodiment, the first polarizer includes a bonding layer, a polarizing layer and a protective layer that are sequentially arranged in the first direction.

The light transmission holes extend through the bonding layer and the polarizing layer in the first direction.

In an embodiment, an anti-reflection layer is arranged in each of the light-transmitting holes.

The anti-reflection layer is bonded to a side of the protection layer facing the display module.

In an embodiment, an orthographic projection of each of the light transmission holes on a reference plane is positioned within an orthographic projection of the corresponding functional hole on the reference plane.

The reference plane is perpendicular to the first direction.

In an embodiment, the orthographic projection of each of the light transmission holes on the reference plane has a first contour, and the orthographic projection of each of the functional holes on the reference plane has a second contour.

A distance between the first contour and the corresponding second contour is 0.5 mm.

In an embodiment, the display module includes an array substrate, an ink layer and a color filter that are sequentially arranged in the first direction.

The functional holes are positioned in the ink layer, and the first polarizer is arranged on a side of the color filter away from the ink layer.

In an embodiment, the display module further includes a second polarizer arranged on a side of the array substrate away from the ink layer.

The second polarizer is positioned in a display area of the display module.

According to another aspect of the present disclosure, an embodiment of the present disclosure provides a display device, including the display panel as described in any one of the above embodiments.

According to yet another aspect of the present disclosure, an embodiment of the present disclosure provides an electronic device, including the display panel as described in any one of the above embodiments.

According to still another aspect of the present disclosure, an embodiment of the present disclosure provides a manufacturing method of a display panel, which is configured to manufacture the display panel as described in any one of the above embodiments. The manufacturing method includes:
arranging the light transmission holes on the first polarizer; and
attaching the first polarizer to the display side of the display module in the first direction.

In an embodiment, the manufacturing method further includes arranging a transparent filling layer or an anti-reflection layer in each of the light-transmitting holes.

In the above display panel, manufacturing method of the display panel, display device, and electronic device, the display panel at least includes the display module and the first polarizer. The light transmission holes corresponding to the functional holes of the display module one by one are arranged on the first polarizer, and the light transmission holes are independent of each other, so that the portions where the light transmission holes are arranged have a discontinuous structure, thereby reducing the portions of the first polarizer to be removed, so that the problem that the display panel presents different colors can be improved, the integrity of the display panel can be improved, and the appearance of the display panel can be improved.

Additional aspects and advantages of the embodiments of the present disclosure are set forth in part in the following description, and part thereof will be apparent from the following description, or learned through practice of the embodiments of the present disclosure.

### BRIEF DESCRIPTION OF THE DRAWINGS

Various other advantages and benefits will become apparent to those of ordinary skill in the art upon reading the following detailed description of the preferred embodiments. The drawings are only for the purpose of illustrating the preferred embodiments and are not to be considered as limiting the disclosure. Also, throughout the drawings, the same components are denoted by the same reference numerals, in which:

FIG. 1 is a schematic view showing an appearance of a display panel according to an embodiment of the related art;

FIG. 2 is a schematic view of a display panel according to another embodiment of the related art;

FIG. 3 is a schematic view of a display panel according to yet another embodiment of the related art;

FIG. 4 is a schematic view showing a part of the display panel shown in FIG. 3 from another perspective;

FIG. 5 is a schematic cross-sectional view of a display panel according to an embodiment of the present disclosure from a perspective;

FIG. 6 is a schematic view showing a part of the display panel shown in FIG. 5 from another perspective;

FIG. 7 is a schematic cross-sectional view of a display panel according to another embodiment of the present disclosure from one perspective;

FIG. 8 is a schematic view showing a part of the display panel shown in FIG. 7 from another perspective;

FIG. 9 is a schematic cross-sectional view of a display panel according to yet another embodiment of the present disclosure from one perspective;

FIG. 10 is a schematic view showing a part of the display panel shown in FIG. 9 from another perspective;

FIG. 11 is a schematic cross-sectional view of a display panel according to yet another embodiment of the present disclosure from a perspective;

FIG. 12 is a schematic view showing a part of the display panel shown in FIG. 11 from another perspective;

FIG. 13 is a schematic cross-sectional view of a display panel according to yet another embodiment of the present disclosure from a perspective;

FIG. 14 is a schematic view showing a part of the display panel shown in FIG. 13 from another perspective;

FIG. 15 is a schematic view showing a projection relationship between a light transmission hole and a functional hole of the display panel shown in FIG. 5; and

FIG. 16 is a schematic flowchart of a manufacturing method of a display panel according to an embodiment of the present disclosure.

Brief illustration for reference numerals:

| | |
|---|---|
| 10: display panel | a1: functional opening area |
| a2: non-functional opening area | 11: first polarizer |
| 11a: protective layer | 11b: polarizing layer |
| 11c: first bonding layer | 12: color filter |
| 13: ink layer | k: functional hole |
| 14: array substrate | 15: second polarizer |
| 16: anti-reflection layer | 17: second bonding layer |
| g: gap | |
| 100: display panel | 110: display module |
| k1: functional hole | z1: non-display area |
| z2: display area | s1: display side |
| 111: array substrate | 112: ink layer |
| 113: color filter | 114: second polarizer |
| 120: first polarizer | k2: light transmission hole |
| 121: bonding layer | 122: polarizing layer |
| 123: protective layer | 130: anti-reflection layer |
| 140: pressure-sensitive adhesive layer | 150: transparent filling layer |
| h1: first thickness | h2: second thickness |
| R: reference plane | y1: first projection |
| y2: second projection | d: distance |
| F1: first direction | |

### DETAILED DESCRIPTION OF THE EMBODIMENTS

In order to make the above objects, features and advantages of the present disclosure more obvious and understandable, the specific implementations of the embodiments of the present disclosure are described in detail below in conjunction with the accompanying drawings. Many specific details are set forth in the following description to facilitate a full understanding of the embodiments of the present disclosure. It should be understood that the specific embodiments described herein are only used to illustrate the present disclosure, and are not intended to limit the present disclosure. The embodiments of the present disclosure can be implemented in many other ways different from those described herein, and those skilled in the art can make similar improvements without violating the connotation of the present disclosure. Therefore, the embodiments of the present disclosure are not limited by the specific embodiments disclosed below.

It can be understood that the terms “first” and “second” used in this disclosure can be used to describe various technical terms herein, and should not be understood as indicating or implying relative importance or implicitly indicating the quantity of indicated technical features. However, unless otherwise specified, these technical terms are not limited by these terms. These terms are only used to distinguish one term from another. In the description of the embodiments of the present disclosure, “multiple” and “several” mean at least two, such as two, three, etc., unless otherwise specifically defined.

In the description of the embodiments of the present disclosure, unless otherwise clearly specified and limited, terms such as “mounting”, “coupling”, “connecting”, and “fixing” should be understood in a broad sense, for example, it may be a fixed connection, or a detachable connection, or integrated; it may be a mechanical connection, or it may be an electrical connection; or it may be a direct connection or an indirect connection through an intermediate medium; or it may be the internal communication of two elements or the interaction relationship between two elements, unless otherwise clearly defined. Those of ordinary skill in the art can understand the specific meanings of the above terms in the embodiments of the present disclosure according to specific situations.

In the description of the embodiments of the present disclosure, unless otherwise specified and limited, a first feature being “on” or “under” a second feature may mean that the first feature being in direct contact with the second feature, or the first feature being indirect contact with the second feature through an intermediate medium. Moreover, a first feature being “above”, “over” and “on the top of” a second feature may mean that the first feature being directly above or obliquely above the second feature, or simply means that the level of the first feature being higher than the level of the second feature. A first feature being “below”, “under” and “underneath” a second feature may mean that the first feature being directly below or obliquely below the second feature, or simply means that the level of the first feature being smaller than the level of the second feature.

It should be noted that when an element is referred to as being “fixed on” or “arranged on” another element, it may be directly on the other element or there may be an intermediate element. When an element is referred to as being “connected to” another element, the element can be directly connected to the other element or an intermediate element may also be present.

Unless otherwise defined, all technical and scientific terms used in this disclosure have the same meaning as commonly understood by one of ordinary skill in the technical field to which this disclosure belongs. The terms used in the description of the present disclosure are only for the purpose of describing specific embodiments, and are not intended to limit the present disclosure.

Currently, in order to meet use requirements of thinner and lighter display panels with narrow borders, functional devices such as photosensitive devices (such as cameras, infrared (IR) cameras) are designed and integrated into a display panel module corresponding to light transmission holes on a protective glass, to remove a protective glass layer. Therefore, it is necessary to remove a polarizer and a part of an ink layer corresponding to functional devices to form a functional opening area.

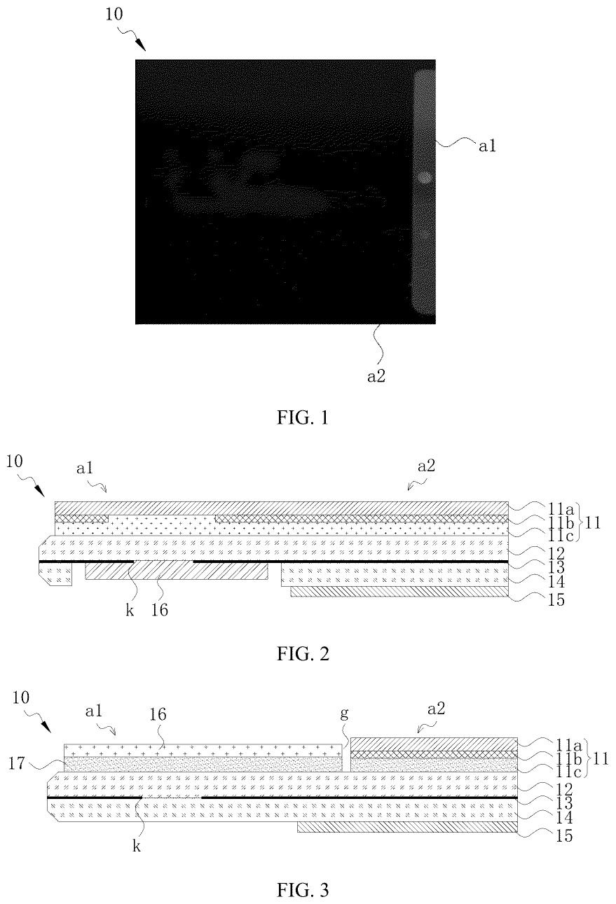

FIG. 1 is a schematic view showing an appearance of a display panel 10 according to an embodiment of the related art; and for ease of illustration, only the content related to an embodiment of the related art is shown.

Referring to FIG. 1, the display panel 10 according to an embodiment of the related art is provided with the above-mentioned functional opening area a1. It can be seen that due to the fact that light may be transmitted through, reflected or refracted on a film layer positioned in the functional opening area a1, the part of the display panel 10 positioned in the functional opening area a1 and the part positioned in a non-functional opening area a2 present different colors, thereby affecting the integrity of the display panel 10.

FIG. 2 is a schematic view of a display panel 10 according to another embodiment of the related art; and for ease of illustration, only content related to the embodiment of the related art is shown.

Referring to FIG. 2, another embodiment of the related art provides the display panel 10, which includes a first polarizer 11, a color filter 12, an ink layer 13, an array substrate 14 and a second polarizer 15, arranged in sequence. The first polarizer 11 includes a protective layer 11a, a polarizing layer 11b and a first bonding layer 11c, arranged in sequence. The ink layer 13 is provided with a functional holes k. The first polarizer 11 is arranged on the color filter 12 via the first bonding layer 11c. The corresponding portion on the polarizing layer 11b is removed by chemical removal or physical removal, and then the first bonding layer 11c is filled. Then, the corresponding portion on the array substrate 14 is removed, and an anti-reflection layer 16 is attached correspondingly. Thus, the problem of the integrity of the display panel 10 as mentioned above can be solved. However, in this process, operations are cumbersome.

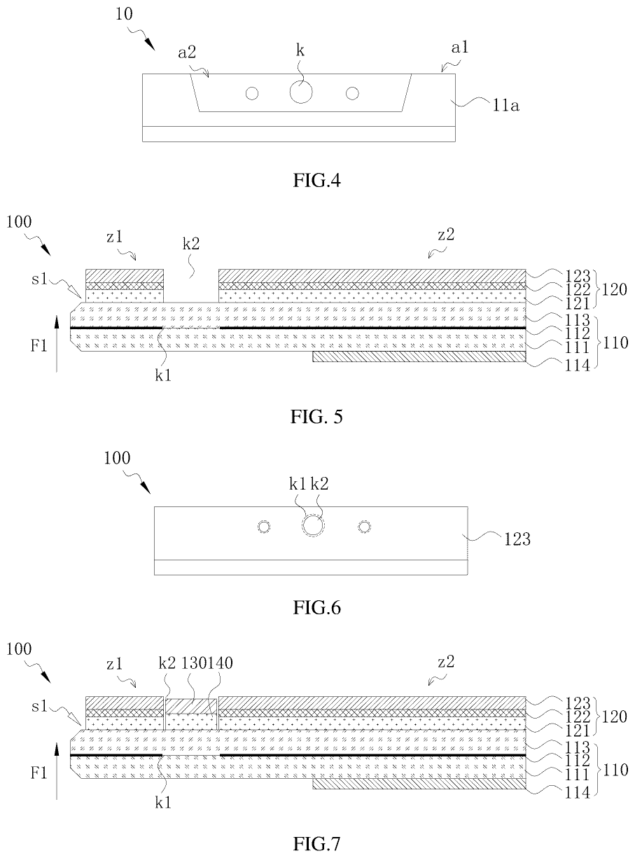

FIG. 3 is a schematic view of a display panel 10 according to yet another embodiment of the related art. FIG. 4 is a schematic view showing a part of the display panel shown in FIG. 3 from another perspective. For ease of illustration, only content related to the embodiment of the related art is shown. The perspective in FIG. 4 is the top view in FIG. 3.

Referring to FIGS. 3 and 4, another embodiment of the related art provides a display panel 10, which differs from the display panel 10 shown in FIG. 2 lies in that after a first polarizer 11 is attached to a color filter 12, a first polarizer 11 positioned at a functional opening area a1 is removed by laser cutting or the like. Then, an anti-reflection layer 16 is arranged on the color filter 12 at the functional opening area a1 by means of the second bonding layer 17. In this way, not only the aforementioned integrity problem of the display panel 10 can be solved, but also the overall operations are simple.

However, during the above process, a gap g may be formed between the anti-reflection layer 16 and the first polarizer 11, resulting in foreign matter such as dust accumulating in the gap g. in addition, since the first polarizer 11 is bonded to the color filter 12 by means of the first bonding layer 11c, the first bonding layer 11c may partially remain on the color filter 12 when removed. The remaining portion of the first bonding layer 11c is difficult to be removed by cleaning and tends to produce burrs. Therefore, the display panel 10 also faces a problem of unsightly appearance.

Accordingly, in order to solve at least part of the above-mentioned problems, embodiments of the present disclosure provide a display panel. By arranging the above-mentioned functional opening area a1 as a discontinuous structure, the problem of different colors of the display panel can be improved, the integrity of the display panel can be improved, and the appearance of the display panel can be improved.

The display panel according to the embodiments of the present disclosure are further described below with reference to the content in some embodiments and related drawings.

FIG. 5 is a schematic cross-sectional view of a display panel 100 according to an embodiment of the present disclosure from a perspective; FIG. 6 is a schematic view showing a part of the display panel 100 shown in FIG. 5 from another perspective. For case of illustration, only content related to the embodiment of the related art is shown. The another perspective in FIG. 6 is the top view in FIG. 5.

In some embodiments, referring to FIGS. 5 and 6, the embodiment of the present disclosure provides a display panel 100. The display panel 100 includes a display module 110 and a first polarizer 120.

A side of the display module 110 in a first direction F1 is a display side s1. In other word, the display side s1 may be referred to as an upper surface of the display module 110, in a direction directed by the arrow F1. The display module 110 includes a non-display area z1 and a display area z2. A plurality of functional holes k1 are arranged in the non-display area z1 of the display module 110 in the first direction F1. Specifically, in some embodiments, the display module 110 includes a second polarizer 114, an array substrate 111, an ink layer 112, and a color filter 113 that are sequentially arranged in the first direction F1. The functional holes k1 are positioned on the ink layer 112. The second polarizer 114 is positioned in the display area z2 of the display module 110.

The first polarizer 120 is arranged on the display side s1 of the display module 110 in the first direction F1. That is, in a case shown in FIG. 5, the first polarizer 120 is arranged on a side of the color filter 113 away from the ink layer 112. The first polarizer 120 is provided with a plurality of light transmission holes k2 independent of each other in the first direction F1. The light transmission holes k2 correspond to the functional holes k1 one by one. That is, the number and positions of the light transmission holes k2 correspond to the number and positions of the functional holes k1 one by one. The light transmission holes k2 and the functional holes k1 together avoid the position of the used functional device.

It should be noted that the arrangement of the functional holes k1 is related to the relevant functional devices. The functional hole k1 can be a camera hole, an IR hole (distance hole and light sensing hole), an LED hole (an indicator light hole for incoming call and charging state), a fingerprint recognition hole, etc., which can be arranged according to the use requirements, and is not specifically limited in the embodiments of the disclosure. Specifically, in some embodiments, the ink layer 112 can be arranged to have a single-layer structure, or can be arranged to have a multi-layer structure. Since the ink layer 112 is provided with the functional holes k1, when the ink layer 112 has a multi-layer structure, sizes of the holes on the ink layer of each layer can be controlled so that hole sizes of the functional holes k1 remain constant or gradually increase or decrease in the first direction F1, so as to be adapted to different functional devices. Taking the functional device as a fingerprint recognition module as an example, the hole sizes of the functional holes k1 gradually increases or decreases in the first direction F1, which can absorb impurity light, reduce external interference, and improve the sensitivity of the fingerprint recognition module. The ink layer 112 can be arranged according to actual use requirements, which is not specifically limited in the embodiments of the present disclosure.

Therefore, by arranging the light transmission holes k2 corresponding to the functional holes k1 of the display module 110 one by one on the first polarizer 120, and arranging the light transmission holes k2 to be independent of each other, portions where the light transmission holes k2 are provided have a discontinuous structure, which has a simple operation, and can reduce the portions of the first polarizer 120 to be removed, thereby improving the problem that the display panel 100 presents different colors, and improving the integrity of the display panel 100. In addition, since the light transmission holes k2 are independent of each other, the resulted gaps have sizes less than those of the gaps in the related art, which can also improve the above-mentioned problem of foreign matter accumulation, and further improve the appearance of the display panel 100.

In some embodiments, continuing to refer to FIG. 5, the first polarizer 120 includes a bonding layer 121, a polarizing layer 122 and a protective layer 123 that are sequentially arranged in the first direction F1. The bonding layer 121 may be made of pressure sensitive adhesive. The light transmission holes k2 extend through the bonding layer 121, the polarizing layer 122 and the protection layer 123 in the first direction F1. In this way, before the first polarizer 120 is attached to the display module 110, the light transmission holes k2 can be formed in the first polarizer 120 through a punching process, which makes the manufacturing process more convenient, and can also improve the aforementioned problem of the partially remaining bonding layer.

In some embodiments, a filling layer may be arranged in the light transmission hole k2 to further improve the integrity of the display panel 100 and improve the appearance of the display panel 100.

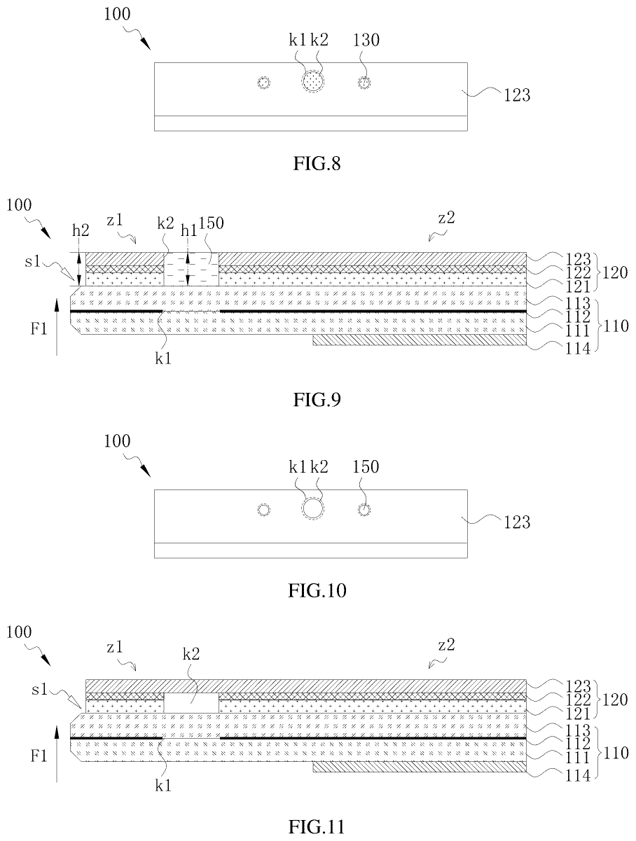

FIG. 7 is a schematic cross-sectional view of a display panel 100 according to another embodiment of the present disclosure from a perspective; FIG. 8 is a schematic view showing a part of the display panel 100 shown in FIG. 7 from another perspective. For ease of illustration, only content related to the embodiments of the present disclosure is shown. The perspective in FIG. 8 is the top view in FIG. 7.

Specifically, in some embodiments, referring to FIGS. 7 and 8, the filling layer may be an anti-reflection layer 130 arranged in the light transmission hole k2. The anti-reflection layer 130 is bonded to the display side s1 of the display module 110. FIG. 7 schematically illustrates the case where the anti-reflection layer 130 is bonded to the color filter 113. In this way, the differences between the various portions of the display panel 100 can be further reduced by means of the anti-reflection layer 130.

As an implementation, continuing to refer to FIGS. 7 and 8, in the first direction F1, a plane where a side of the anti-reflection layer 130 away from the display module 110 is positioned, is located upstream of a plane where a side of the protective layer 123 away from the display module 110 is positioned. That is, the anti-reflection layer 130 is positioned in the light transmission hole k2. In this way, it is possible to prevent the anti-reflection layer 130 from protruding from the protection layer 123 and causing the unattractive appearance of the display panel 100. Optionally, the anti-reflection layer 130 can be bonded to the color filter 113 by means of a pressure-sensitive adhesive layer 140, so that the anti-reflection layer 130 is positioned in the light transmission hole k2 by means of the pressure-sensitive adhesive layer 140.

FIG. 9 is a schematic cross-sectional view of a display panel 100 according to yet another embodiment of the present disclosure from a perspective; FIG. 10 is a schematic view showing a part of the display panel 100 shown in FIG. 9 from another perspective. For ease of illustration, only content related to the embodiments of the present disclosure is shown. The perspective in FIG. 10 is the top view in FIG. 9.

Specifically, in other embodiments, specifically, referring to FIGS. 9 and 10, the filling layer may be a transparent filling layer 150 filled in the light transmission hole k2. Optionally, a thickness of the transparent filling layer 150 is a first thickness h1, a thickness of the first polarizer 120 is a second thickness h2, and the first thickness h1 is less than or equal to the second thickness h2. In this way, a surface of the display panel 100 can be made smoother, and the problem of foreign matter accumulation can be further improved. The transparent filling layer 150 is configured to be made of a material with a light transmittance greater than 90%. For example, the transparent filling layer 150 may be transparent glue.

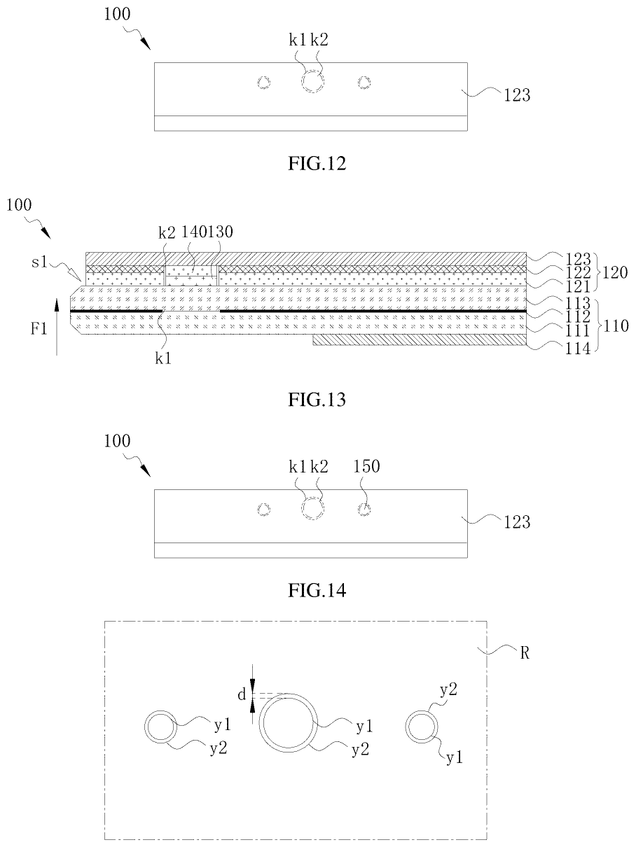

FIG. 11 is a schematic cross-sectional view of a display panel 100 according to yet another embodiment of the present disclosure from a perspective; FIG. 12 is a schematic view showing a part of the display panel 100 shown in FIG. 11 from another perspective. For ease of illustration, only content related to the embodiments of the present disclosure is shown. The perspective in FIG. 12 is the top view in FIG. 11.

In some embodiments, referring to FIGS. 11 and 12, the first polarizer 120 includes a bonding layer 121, a polarizing layer 122 and a protective layer 123 that are sequentially arranged in the first direction F1. The light transmission hole k2 extends through the bonding layer 121 and the polarizing layer 122 in the first direction F1. That is, the light transmission hole k2 is positioned under the protection layer 123. Before the first polarizer 120 is attached to the display module 110, the light transmission hole k2 extending through the bonding layer 121 and the polarizing layer 122 but not extending through the protective layer 123 can be formed through the laser cutting process with controlled the laser energy. In this way, the problem of foreign matter accumulation can be further improved.

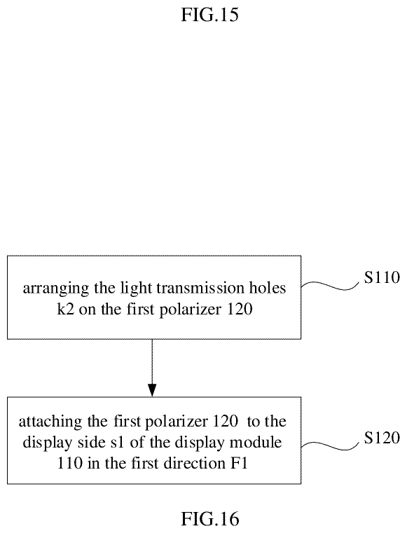

FIG. 13 is a schematic cross-sectional view of a display panel 100 according to yet another embodiment of the present disclosure from a perspective; FIG. 14 is a schematic view showing a part of the display panel 100 shown in FIG. 13 from another perspective. For ease of illustration, only content related to the embodiments of the present disclosure is shown. The perspective in FIG. 14 is the top view in FIG. 13.

In some embodiments, referring to FIGS. 13 and 14, an anti-reflection layer 130 is arranged in the light transmission hole k2. The anti-reflection layer 130 is bonded to a side of the protective layer 123 facing the display module 110. In some other embodiments, the anti-reflection layer 130 may also be bonded to a side of the color filter 113 facing the protective layer 123. Optionally, the anti-reflection layer 130 can be bonded to the corresponding structure by means of a pressure-sensitive adhesive layer 140. In this way, the differences on the surface of the display panel 100 can be further reduced, and the integrity of the display panel 100 can be further improved.

FIG. 15 a schematic view showing a projection relationship between light transmission holes k2 and functional holes k1 of the display panel shown in FIG. 5. For ease of illustration, only content related to the embodiments of the present disclosure is shown.

In some embodiments, referring to FIGS. 15 and 5, a plane perpendicular to the first direction F1 is defined as a reference plane R. Orthographic projections of the light transmission holes k2 on the reference plane are first projections y1, orthographic projections of the functional holes k1 on the reference plane are second projections y2, and the first projections y1 are positioned within the corresponding second projections y2. That is, the size of the light transmission hole k2 is less than the size of the functional hole k1. In this way, the color differences on the surface of the display panel 100 caused by inks on edges of the functional holes k1 not being covered by the first polarizer 120 can be improved, thereby improving the integrity of the display panel 100.

In some embodiments, referring to FIGS. 15 and 5, each of the first projections y1 has a first contour (not denoted in the figure), and each of the second projections y2 has a second contour (not denoted in the figure). A distance d between the first contour and the corresponding second contour is 0.5 mm. In this way, the above-mentioned color differences caused by the inks on the edges of the functional holes k1 not being covered by the first polarizer 120 which is due to too large light transmission holes k2 can be improved, and the problem of the use of functional devices being affected by too small light transmission holes k2 can also be improved. For example, when the functional device is a camera, if the light transmission hole k2 is too small in size, the visual edge of the camera may be covered by the first polarizer 120 such that the entrance of the light is blocked, so that the edge cannot be imaged, which will affect the capturing of the camera.

Embodiments of the present disclosure further provide a display device, including the display panel 100 according to any of the above embodiments. Since the display device includes the display panel 100 according to any of the foregoing embodiments, the display device has all the advantages brought by the display panel 100, and which will not be repeated herein.

Embodiments of the present disclosure further provide an electronic device, including the display panel 100 according to any of the above embodiments. Since the electronic device includes the display panel 100 according to any of the foregoing embodiments, the electronic device has all the advantages brought by the display panel 100, and which will not be repeated herein.

The above-mentioned display device and electronic device can be applied to fields such as mobile phone terminals, bionic electronics, electronic skins, wearable device, in-vehicle device, Internet of Things devices, and artificial intelligence devices. For example, the above-mentioned electronic device may be a mobile phone terminal, a tablet, a palmtop computer, an iPod, a smart watch, a laptop computer, a television set, a monitor, or the like.

FIG. 16 is a schematic flowchart of a manufacturing method of a display panel 100 according to an embodiment of the present disclosure. For case of illustration, only content related to the embodiments of the present disclosure is shown.

In some embodiments, embodiments of the present disclosure further provide a manufacturing method of a display panel 100, which is used to manufacture the display panel 100 according to any of the above embodiments. Referring to FIG. 16, the manufacturing method includes the following steps of S110 to S120.

At S110, the light transmission holes k2 are arranged on the first polarizer 120.

Specifically, reference may be made to the content in some foregoing embodiments. As shown in FIGS. 5, 7 and 9, when the light-transmitting holes k2 extend through the bonding layer 121, the polarizing layer 122 and the protective layer 123 in the first direction F1, the light-transmitting holes k2 can be formed in the first polarizer 120 by a punching process. As shown in FIGS. 11 and 13, when the light-transmitting holes k2 extend through the bonding layer 121 and the polarizing layer 122 in the first direction F1, the required light-transmitting holes k2 can be formed through a laser cutting process with a controlled cutting force.

At S120, the first polarizer 120 is attached to the display side s1 of the display module 110 in the first direction F1.

Specifically, after the light transmission holes k2 are formed, as shown in FIGS. 5 to 14, the first polarizer 120 is bonded to the display side s1 of the display module 110, which can improve the aforementioned problem of the partially remaining bonding layer, and further improve the appearance of the display panel 100.

In some embodiments, continuing to refer to FIGS. 7, 9 and 13, the transparent filling layer 150 or the anti-reflection layer 130 is arranged in the light transmission hole k2. For details, reference may be made to the content in some foregoing embodiments, and details thereof are not repeated herein.

To sum up, in the embodiments of the present disclosure, the light transmission holes k2 corresponding to the functional holes k1 of the display module 110 one by one are arranged on the first polarizer 120, and the light transmission holes k2 are independent of each other, so that the portions where the light transmission holes k2 are arranged have a discontinuous structure, thereby reducing the portions of the first polarizer 120 to be removed, so that the problem that the display panel 100 presents different colors can be improved, the integrity of the display panel 100 can be improved, and the appearance of the display panel 100 can be improved. By arranging the matching relationship between the light transmission holes k2 and the functional holes k1, it can not only avoid affecting the use of functional devices, but also improve the integrity of the display panel 100. In addition, by changing the way of the light transmission holes k2 extending through the first polarizer 120 and using the anti-reflection layer 130 or the transparent filling layer 150, the overall manufacturing process can be made more flexible, and is convenient to be selected according to the use scene, which further improves the integrity of the display panel 100 and improved the overall appearance. In addition, since the first polarizer 120 is provided with the light-transmitting holes k2 before being attached to the display module 110, the bonding problem is avoided, and the required light-transmitting holes k2 are easy to be manufactured.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variants and improvements without departing from the concept of the present disclosure, and the variants and improvements falls in the protection scope of the present disclosure. Therefore, the protection scope of the present disclosure shall be subject to the appended claims.

What is claimed is:

1. A display panel, comprising:
a display module comprising a non-display area, and a plurality of functional holes being arranged in the non-display area in a first direction; and
a first polarizer arranged on a display side of the display module in the first direction,
wherein the first polarizer is provided with a plurality of light transmission holes independent of each other in the first direction, and the light transmission holes correspond to the functional holes one by one.

2. The display panel according to claim 1, wherein the first polarizer comprises a bonding layer, a polarizing layer and a protective layer that are sequentially arranged in the first direction; and
the light transmission holes extend through the bonding layer, the polarizing layer and the protection layer in the first direction.

3. The display panel according to claim 2, wherein an anti-reflection layer is arranged in each of the light transmission holes; and
the anti-reflection layer is bonded to the display side of the display module.

4. The display panel according to claim 3, wherein in the first direction, a plane where a side of the anti-reflection layer away from the display module is positioned, is located upstream of a plane where a side of the protective layer away from the display module is positioned.

5. The display panel according to claim 2, wherein a transparent filling layer is filled in each of the light transmission holes.

6. The display panel according to claim 5, wherein a thickness of the transparent filling layer is less than or equal to a thickness of the first polarizer.

7. The display panel according to claim 1, wherein the first polarizer comprises a bonding layer, a polarizing layer and a protective layer that are sequentially arranged in the first direction; and
the light transmission holes extend through the bonding layer and the polarizing layer in the first direction.

8. The display panel according to claim 7, wherein an anti-reflection layer is arranged in each of the light-transmitting holes; and
the anti-reflection layer is bonded to a side of the protection layer facing the display module.

9. The display panel according to claim 1, wherein an orthographic projection of each of the light transmission holes on a reference plane is positioned within an orthographic projection of the corresponding functional hole on the reference plane; and
the reference plane is perpendicular to the first direction.

10. The display panel according to claim 9, wherein the orthographic projection of each of the light transmission holes on the reference plane has a first contour, and the orthographic projection of each of the functional holes on the reference plane has a second contour; and
a distance between the first contour and the corresponding second contour is 0.5 mm.

11. The display panel according to claim 1, wherein the display module comprises an array substrate, an ink layer and a color filter that are sequentially arranged in the first direction; and
the functional holes are positioned in the ink layer, and the first polarizer is arranged on a side of the color filter away from the ink layer.

12. The display panel according to claim 11, wherein the display module further comprises a second polarizer arranged on a side of the array substrate away from the ink layer; and
wherein the second polarizer is positioned in a display area of the display module.

13. A display device, comprising the display panel according to claim 1.

14. An electronic device, comprising the display panel according to claim 1.

15. A manufacturing method of a display panel, configured to manufacture the display panel according to claim 1; the manufacturing method comprising:
arranging the light transmission holes on the first polarizer; and
attaching the first polarizer to the display side of the display module in the first direction.

16. The manufacturing method according to claim 15, further comprising:
arranging a transparent filling layer or an anti-reflection layer in each of the light-transmitting holes.
